(19) United States
(12) Patent Application Publication
(10) Pub. No.: US 2023/0294268 A1
(43) Pub. Date: Sep. 21, 2023

(54) Overlap-type Supporting and Fixing Structure for Painting

(71) Applicant: Guangzhou LI Chui Trading Co., Ltd., Guangzhou (CN)

(72) Inventor: MeiJian Deng, Guangzhou (CN)

(21) Appl. No.: 17/699,076

(22) Filed: Mar. 19, 2022

(51) Int. Cl. B25H 1/08

(52) U.S. Cl. CPC B25H 1/08

(57) ABSTRACT

The present invention adopts an overlap-type supporting and fixing structure for painting, which includes a support frame, and a fixed end is located on the top of such support frame for the purpose of bolting, while an embedding trough structure is established on its bottom to allow the bolt fixed end to be completed embedded into it; The bottom of the right half part of the front end of the support frame is provided with a first embedding tooth structure which has a continuous toothlike structure, and the top of the first embedding tooth structure is equipped with a first embedding trough structure which matches the shape of the first embedding tooth structure and allows the first embedding tooth structure to be exactly embedded into it; When the up-down overlapping has been realized between one support frame and another identical support frame, the connecting embedding trough of the upper support frame will be embedded into the connecting seat of the lower support frame; Meanwhile, the first embedding tooth structure of the upper support frame will be embedded into the first embedding trough structure of the lower support frame, and the second embedding tooth structure of the upper support frame will be embedded into the second embedding trough structure, The present invention adopts an overlap-type supporting and fixing structure, whereby the door panel can be rotated conveniently after fixation, and multiple door panels can be air-cured and stored by way of superimposition.

### TECHNICAL FIELD

The present invention relates to the technical field of spray painting auxiliary equipment, in particular concerns an overlap-type supporting and fixing structure for painting.

### BACKGROUND ART

In the current market environment, when painting the door panel, a layer of film will be first laid on the ground, and the door panel will be placed on such film thereafter. One side just sprayed by the painter will be set aside to dry before spraying the other side. There are disadvantages of such operations: Low efficiency, low production capacity, waste of space, serious environmental pollution, and high labor costs.

### CONTENT OF THE INVENTION/SUMMERY

Citing the above problems, the present invention proposes an overlap-type supporting and fixing structure for painting to address these issues.

In order to reach the above technological objectives, the present invention adopts an overlap-type supporting and fixing structure for painting, which includes a support frame, and a fixed end is located on the top of such support frame for the purpose of bolting, while an embedding trough structure is established on its bottom to allow the bolt fixed end to be completed embedded into it; The bottom of the right half part of the front end of the support frame is provided with a first embedding tooth structure which has a continuous toothlike structure, and the top of the first embedding tooth structure is equipped with a first embedding trough structure which matches the shape of the first embedding tooth structure and allows the first embedding tooth structure to be exactly embedded into it;

The bottom of the left half part of the back end of the support frame is provided with a second embedding tooth structure which has a continuous toothlike structure, and the top of the second embedding tooth structure is equipped with a second embedding trough structure which matches the shape of the second embedding tooth structure and allows the second embedding tooth structure to be exactly embedded into it.

The preferred bolt fixed end includes: A connecting seat with horizontal expansion towards the front end and back end of the support frame, and there is a lateral connecting hole between the front end and back end of the connecting seat, where the bolt can pass through; The left side and right side of the connecting seat are respectively provided with a landscape left support rod and a landscape right support rod featuring an inclined structure;

The embedding trough structure includes: A connecting embedding trough located at the bottom of the support frame, and with horizontal expansion towards the front end and back end of the support frame, and the shape of the inner wall of the connecting embedding trough matches that of the outer wall of the connecting seat.

After the connecting embedding trough's front half located on the front end face of the support frame continuously extends laterally to the left, a first convex platform comes into existence on the left half of the front end face of the support frame; The connecting embedding trough's front half located on the front end face of the support frame will connect to the left side of the first embedding tooth structure after continuously extending laterally in the lower right direction;

After the connecting embedding trough's latter part located on the back face of the support frame continuously extends laterally to the left, a second convex platform comes into existence on the left half of the front end face of the support frame; The connecting embedding trough's latter part located on the back face of the support frame will connect to the left side of the second embedding tooth structure after continuously extending laterally in the lower right direction;

The landscape right support rod of the connecting seat will connect to left side of the first embedding trough structure after extending along the lower right side of the front end face of the support frame; The landscape left support rod of the connecting seat will connect to right side of the second embedding trough structure after extending along the lower left side of the back face of the support frame.

The first convex platform and the second convex platform are the same shape and size; The first embedding tooth structure and the second embedding tooth structure are the same shape and size; The first embedding trough structure and the second embedding trough structure are the same shape and size.

Further, the middle position of the support frame is provided with a pressure-bearing hole structure extending towards the front end face and back face of the support frame, which is located on the top of the left half pressure-bearing hole structure on the front end face of the support frame, and connected to the landscape left support rod of the connecting seat; The pressure-bearing hole structure is located on the top of the right half pressure-bearing hole structure on the back face of the support frame, and connected to the landscape right support rod of the connecting seat, and located between the bottom of the connecting seat and the top of the connecting embedding trough.

Further, the front end of the first convex platform and the support frame are provided with the first pressure-bearing inclined hole featuring the laterally through-going structure between them; the front end of the second convex platform and the support frame are provided with the second pressure-bearing inclined hole featuring the laterally through-going structure between them.

Further, the left side of the support frame is equipped with a left pressure-bearing hole structure that runs front and back, which is located between the second embedding teeth and the second embedding trough; The right side of the support frame is equipped with a right pressure-bearing hole structure that runs front and back, which is located between the first embedding teeth and the first embedding trough;

Preferably, the number of the left pressure-bearing hole structures is three, which are equally spaced and characterized by horizontal spacing, while featuring an isosceles trapezoidal structure; The number of the right pressure-bearing hole structures is three, which are equally spaced and characterized by horizontal spacing, while featuring an isosceles trapezoidal structure.

[symbol] The present invention adopts an overlap-type supporting and fixing structure, whereby the door panel can be rotated conveniently after fixation, and multiple door panels can be air-cured and stored by way of superimposition. It has the following advantages: Efficient, driving the spray painting industry to move forward efficiently, and creating time-saving and effort-saving values for users; Reusable, compared with traditional operation methods, capable of mitigating environmental pollution; Space saving, compared with traditional operation methods, the space-saving ability is 12 times higher; Able to accelerate the removal of unpleasant odors through an aerial support design, while protecting human health and realizing fast turnaround.

### DESCRIPTION OF FIGURES

FIG. 1 is the front appearance structure diagram of the present invention;

FIG. 2 is the back appearance structure diagram of the present invention;

FIG. 3 is the structure diagram displaying the overlay of two door panels under the action of multiple support frames.

### SPECIFIC EMBODIMENTS

Below with reference to the drawings and specific embodiments the present invention is further described.

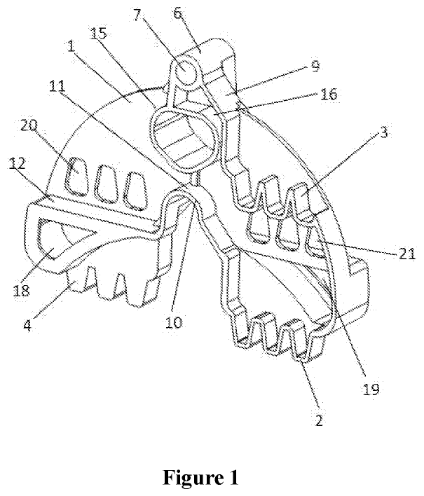

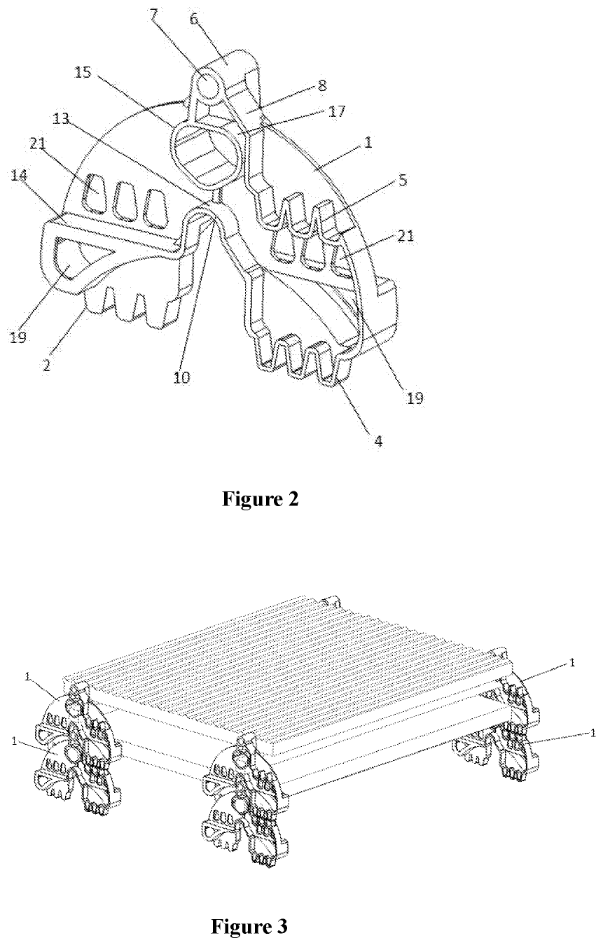

With reference to FIG. 1 and FIG. 2, an overlap-type supporting and fixing structure for painting, which includes a support frame 1, and a fixed end is located on the top of support frame 1 for the purpose of bolting, while an embedding trough structure is established on the bottom of the support frame 1 to allow the bolt fixed end to be completed embedded into it; The bottom of the right half part of the front end of the support frame 1 is provided with a first embedding tooth structure 2 which has a continuous toothlike structure, and the top of the first embedding tooth structure 2 is equipped with a first embedding trough structure 3 which matches the shape of the first embedding tooth structure 2 and allows the first embedding tooth structure 2 to be exactly embedded into it;

The bottom of the left half part of the back end of the support frame 1 is provided with a second embedding tooth structure 4 which has a continuous toothlike structure, and the top of the second embedding tooth structure 4 is equipped with a second embedding trough structure 5 which matches the shape of the second embedding tooth structure 4 and allows the second embedding tooth structure 4 to be exactly embedded into it.

On the left side of the support frame 1, there are three left pressure-bearing hole structures 20 that runs front and back and features an isosceles trapezoidal structure; and the left pressure-bearing hole structures 20 is located between the second embedding tooth structure 4 and the second embedding trough structure 5; On the right side of the support frame 1, there are three right pressure-bearing hole structures 21 that runs front and back and features an isosceles trapezoidal structure; and the right pressure-bearing hole structures 21 is located between the first embedding tooth structure 2 and the first embedding trough structure 3.

The preferred bolt fixed end includes: A connecting seat 6 with horizontal expansion towards the front end and back end of the support frame 1, and there is a lateral connecting hole 7 between the front end and back end of the connecting seat 6, where the bolt can pass through; The left side and right side of the connecting seat 6 are respectively provided with a landscape left support rod 8 and a landscape right support rod 9 featuring an inclined structure.

The preferred embedding trough structure includes: A connecting embedding trough 10 located at the bottom of the support frame 1, and with horizontal expansion towards the front end and back end of the support frame 1, and the shape of the inner wall of the connecting embedding trough 10 matches that of the outer wall of the connecting seat 6.

After the connecting embedding trough 10's front half 11 located on the front end face of the support frame 1 continuously extends laterally to the left, a first convex platform 12 comes into existence on the left half of the front end face of the support frame 1; The front end of the first convex platform 12 and the support frame 1 are provided with the first pressure-bearing inclined hole 18 featuring the laterally through-going structure between them; The connecting embedding trough 10's front half 11 located on the front end face of the support frame 1 will connect to the left side of the first embedding tooth structure 2 after continuously extending laterally in the lower right direction;

After the connecting embedding trough 10's latter part 13 located on the back face of the support frame 1 continuously extends laterally to the left, a second convex platform 14 comes into existence on the left half of the front end face of the support frame 1; The front end of the second convex platform 14 and the support frame 1 are provided with the second pressure-bearing inclined hole 19 featuring the laterally through-going structure between them;

The connecting embedding trough 10's latter part 13 located on the back face of the support frame 1 will connect to the left side of the second embedding tooth structure 4 after continuously extending laterally in the lower right direction;

The landscape right support rod 9 of the connecting seat 6 will connect to left side of the first embedding trough structure 3 after extending along the lower right side of the front end face of the support frame 1; The landscape left support rod 8 of the connecting seat 6 will connect to right side of the second embedding trough structure 5 after extending along the lower left side of the back face of the support frame.

In this embodiment, the first convex platform 12 and the second convex platform 14 are the same shape and size; The first embedding tooth structure 2 and the second embedding tooth structure 4 are the same shape and size; The first embedding trough structure 3 and the second embedding trough structure 5 are the same shape and size.

The middle position of the support frame 1 is provided with a pressure-bearing hole structure 15 extending towards the front end face and back face of the support frame, and the pressure-bearing hole structure 15 is located on the top of the left half pressure-bearing hole structure 16 on the front end face of the support frame 1, and connected to the landscape left support rod 8 of the connecting seat 6; The pressure-bearing hole structure 15 is located on the top of the right half pressure-bearing hole structure 17 on the back face of the support frame 1, and connected to the landscape right support rod 9 of the connecting seat 6, and the pressure-bearing hole structure 15 is located between the bottom of the connecting seat 6 and the top of the connecting embedding trough 10.

During use, it allows inserting the screw into a transverse connecting hole 7 between the front end and back end of the connecting seat 6 to connect with the side edge of the door panel. One door panel demands for four support frames 1, thus, in order for the upper and lower door panels to get connected, eight support frames 1 will be used to achieve up-down overlapping (see FIG. 3). If there are more door panels, continue to superimpose with the above method.

When the up-down overlapping has been realized between one support frame 1 and another identical support frame 1, the connecting embedding trough 10 of the upper support frame 1 will be embedded into the connecting seat 6 of the lower support frame 1; Meanwhile, the first embedding tooth structure 2 of the upper support frame 1 will be embedded into the first embedding trough structure 3 of the lower support frame 1, and the second embedding tooth structure 4 of the upper support frame 1 will be embedded into the second embedding trough structure 5 of the lower support frame 1. In this way, two superimposed support frame structures will be established, and so on, multiple support frame structures will come into existence by way of superimposition.

What is claimed is:

1. An overlap-type supporting and fixing structure for painting, comprising: a support frame, and a fixed end is located on the top of the support frame for purpose of bolting, while an embedding trough structure is established on its bottom to allow the bolt fixed end to be completed embedded into it; a bottom of the right half part of the front end of the support frame is provided with a first embedding tooth structure that has a continuous toothlike structure, and the top of the first embedding tooth structure is equipped with a first embedding trough structure that matches the shape of the first embedding tooth structure and allows the first embedding tooth structure to be exactly embedded into it;
a bottom of the left half part of the back end of the support frame is provided with a second embedding tooth structure which has a continuous toothlike structure, and the top of the second embedding tooth structure is equipped with a second embedding trough structure which matches the shape of the second embedding tooth structure and allows the second embedding tooth structure to be exactly embedded into it; and
when the up-down overlapping has been realized between one support frame and another identical support frame, the connecting embedding trough of the upper support frame is embedded into the connecting seat of the lower support frame; meanwhile, the first embedding tooth structure of the upper support frame is embedded into the first embedding trough structure of the lower support frame, and the second embedding tooth structure of the upper support frame will be embedded into the second embedding trough structure.

2. The overlap-type supporting and fixing structure for painting according to claim 1, further comprising: a connecting seat with horizontal expansion towards the front end and back end of the support frame, and there is a lateral connecting hole between the front end and back end of the connecting seat, where the bolt can pass through; the left side and right side of the connecting seat are respectively provided with a landscape left support rod and a landscape right support rod featuring an inclined structure; and
the embedding trough structure includes: A connecting embedding trough located at the bottom of the support frame, and with horizontal expansion towards the front end and back end of the support frame, and the shape of the inner wall of the connecting embedding trough matches that of the outer wall of the connecting seat;
after the connecting embedding trough's front half located on the front end face of the support frame continuously extends laterally to the left, a first convex platform comes into existence on the left half of the front end face of the support frame; The connecting embedding trough's front half located on the front end face of the support frame will connect to the left side of the first embedding tooth structure after continuously extending laterally in the lower right direction;
after the connecting embedding trough's latter part located on the back face of the support frame continuously extends laterally to the left, a second convex platform comes into existence on the left half of the front end face of the support frame; The connecting embedding trough's latter part located on the back face of the support frame will connect to the left side of the second embedding tooth structure after continuously extending laterally in the lower right direction; and
the landscape right support rod of the connecting seat will connect to left side of the first embedding trough structure after extending along the lower right side of the front end face of the support frame; The landscape left support rod of the connecting seat will connect to right side of the second embedding trough structure after extending along the lower left side of the back face of the support frame.

3. The overlap-type supporting and fixing structure for painting according to claim 2, further comprising: the first convex platform and the second convex platform are the same shape and size; The first embedding tooth structure and the second embedding tooth structure are the same shape and size; the first embedding trough structure and the second embedding trough structure are the same shape and size.

4. The overlap-type supporting and fixing structure for painting according to claim 3, further comprising: a middle position of the support frame is provided with a pressure-bearing hole structure extending towards the front end face and back face of the support frame, which is located on the top of the left half pressure-bearing hole structure on the front end face of the support frame, and connected to the landscape left support rod of the connecting seat; the pressure-bearing hole structure is located on the top of the right half pressure-bearing hole structure on the back face of the support frame, and connected to the landscape right support rod of the connecting seat, and located between the bottom of the connecting seat and the top of the connecting embedding trough.

5. The overlap-type supporting and fixing structure for painting according to claim 3, further comprising: the front end of the first convex platform and the support frame are provided with the first pressure-bearing inclined hole featuring the laterally through-going structure between them; the front end of the second convex platform and the support frame are provided with the second pressure-bearing inclined hole featuring the laterally through-going structure between them.

6. The overlap-type supporting and fixing structure for painting according to claim 3, further comprising: the left side of the support frame is equipped with a left pressure-bearing hole structure that runs front and back, which is located between the second embedding teeth and the second embedding trough; The right side of the support frame is equipped with a right pressure-bearing hole structure that runs front and back, which is located between the first embedding teeth and the first embedding trough.

7. The overlap-type supporting and fixing structure for painting according to claim 6, further comprising: the number of the left pressure-bearing hole structures is three, which are equally spaced and characterized by horizontal spacing, while featuring an isosceles trapezoidal structure; the number of the right pressure-bearing hole structures is three, which are equally spaced and characterized by horizontal spacing, while featuring an isosceles trapezoidal structure.
